(19) United States
(12) Patent Application Publication
(10) Pub. No.: US 2026/0238845 A1
(43) Pub. Date: Aug. 13, 2026

(54) REMOTE CONTROL DEVICE AND METHOD FOR CONTROLLING OPERATION OF DISPLAY DEVICE USING SAME

(71) Applicant: LG ELECTRONICS INC., Seoul (KR)

(72) Inventors: Seonil YU, Seoul (KR); Jihan SON, Seoul (KR); Janghee LEE, Seoul (KR)

(73) Assignee: LG ELECTRONICS INC., Seoul (KR)

(21) Appl. No.: 19/118,703

(22) PCT Filed: Oct. 7, 2022
(86) PCT No.: PCT/KR2022/015156

§ 371 Date: Apr. 13, 2026

(51) Int. Cl. H04N 21/422

(52) U.S. Cl. CPC H04N 21/42215; H04N 21/42221

(57) ABSTRACT

The present disclosure relates to a remote control device and a method for controlling the operation of a display device using same, the remote control device comprising: a communication unit; a user input unit including a plurality of user buttons; and a control unit that controls the communication unit to transmit a screen information control signal corresponding to each user button, wherein the control unit may: when a specific button among the plurality of user buttons is pressed, measure press time of the specific button; when the press time of the specific button is less than or equal to a first set time, transmit a screen information control signal including button data to the display device; and when the press time of the specific button exceeds the first set time, transmit a screen information control signal including scroll data to the display device.

### TECHNICAL FIELD

The present disclosure relates to a remote control device capable of controlling a scroll operation of screen information displayed on a display device using a replacement button instead of a wheel button, and a method for controlling an operation of the display device using the remote control device.

### BACKGROUND ART

In general, display devices are devices that have functions of receiving, processing, and displaying images for a user to view. Such a display device receives a broadcast signal selected by the user from broadcast signals transmitted from a broadcasting station, separates a video signal from the received signal, and then displays the separated video signal on a display.

In recent years, due to development of broadcasting and network technologies, the functions of display devices are diversified considerably, and the performance of the devices is also improved. That is, display devices are developed to provide not only simply broadcast contents but also a variety of other contents to the users.

For example, the display device may provide not only programs received from broadcasting stations, but also game play, music appreciation, Internet shopping, and customized information using various applications. To perform these extended functions, the display device may be fundamentally connected to other devices or networks using various communication protocols and may provide ubiquitous computing environment to the users. That is, the display device is evolved into smart devices that enable connectivity to networks and constant computing.

The remote control device may include function buttons having various shapes, which include a wheel button that performs a scroll function, and may allow the user to control the display device through the button selected by the user.

For example, when a user input for selecting a navigation button is received, the remote control device may transmit a control signal to the display device for moving screen information of the display device in vertical and horizontal directions, and the display device may move the screen information in the vertical and horizontal directions in response to the control signal received from the remote control device.

In addition, when the user input for selecting the wheel button is received, the remote control device may transmit the control signal for performing scroll up/down or page up/down of the screen information of the display device to the display device, and the display device may perform the scroll up/down or page up/down of the screen information in response to the control signal received from the remote control device.

However, the wheel button of the remote control device is vulnerable to an introduction of a liquid due to its wheel structure and acts as an element that hinders a slim design.

Therefore, in the future, there is a need to develop the remote control device that is capable of handling the scroll function by removing the wheel button and using another replacement button.

### DISCLOSURE OF THE INVENTION

### Technical Problem

An object of the present disclosure is to solve the above-mentioned problems and other problems.

An object of the present disclosure is to provide a remote control device, in which a screen information control signal containing scroll data is generated on the basis of a press time of a specific button and is transmitted to the display device to control a scroll operation of screen information displayed on the display device while maintaining an existing usability by using a replacement button instead of a wheel button.

### Technical Solution

A remote control device for controlling a display device according to an embodiment of the present disclosure includes a communication unit, a user input unit comprising a plurality of user buttons, and a control unit configured to control the communication unit so as to transmit a screen information control signal corresponding to each of the user buttons, wherein the control unit is configured to measure a press time of a specific button when the specific button of the plurality of user buttons is pressed, transmit a screen information control signal containing button data to the display device when the press time of the specific button is less than or equal to a first set time, and transmit a screen information control signal containing scroll data when the press time of the specific button exceeds the first set time.

A method for controlling an operation of a display device using a remote control device according to an embodiment of the present disclosure includes receiving a user input for pressing a specific button among a plurality of user buttons, measuring a press time of the specific button, confirming whether the press time of the specific button exceeds a first set time, transmitting a screen information control signal, which contains scroll data, to the display device when the press time of the specific button exceeds the first set time, measuring a press time of the specific button, confirming whether the press time of the specific button exceeds a second set time, and transmitting the screen information control signal, which contains the scroll data, to the display device when the press time of the specific button exceeds the second set time.

### Advantageous Effects

According to the embodiment of the present disclosure, the remote control device may generate the screen information control signal containing the scroll data on the basis of the press time of the specific button to transmit the screen information control signal to the display device, thereby controlling the scroll operation of the screen information displayed on the display device while maintaining the existing usability by using the replacement button instead of the wheel button, and thus, the defect rate due to the removal of the wheel button may be improved, the user convenience may be improved, and the slim design may be enabled.

### BRIEF DESCRIPTION OF THE DRAWINGS

FIG. 1 is a block diagram illustrating a configuration of a display device according to an embodiment of the present disclosure.

FIG. 2 is a block diagram illustrating a remote control device according to an embodiment of the present disclosure.

FIG. 3 is a view illustrating an actual configuration of a remote control device according to an embodiment of the present disclosure.

FIG. 4 is a view illustrating an example of utilizing a remote control device according to an embodiment of the present disclosure.

FIG. 5 is a view for explaining a control operation of the display device of the remote control device according to an embodiment of the present disclosure.

FIG. 6 is a view for explaining a user input for generating scroll data of the remote control device according to an embodiment of the present disclosure.

FIG. 7 is a view for explaining a data packet structure of a screen information control signal according to an embodiment of the present disclosure.

FIG. 8 is a view for explaining a data pocket structure of a screen information control signal corresponding to a specific button press time of the remote control device according to an embodiment of the present disclosure.

FIG. 9 is a flowchart for explaining an operation of the remote control device according to an embodiment of the present disclosure.

FIG. 10 is a view for explaining a guide message for activating a scroll function of the remote control device according to an embodiment of the present disclosure.

FIG. 11 is a view for explaining a notification message for notifying start of the activation of the scroll function of the remote control device according to an embodiment of the present disclosure.

FIGS. 12 and 13 are views for explaining a scroll indicator corresponding to a scroll operation of the display device according to an embodiment of the present disclosure.

FIGS. 14 to 18 are views for explaining a scroll operation of the display device according to an embodiment of the present disclosure.

### MODE FOR CARRYING OUT THE INVENTION

Hereinafter, embodiments disclosed in this specification is described with reference to the accompanying drawings, and the same or corresponding components are given with the same drawing number regardless of reference number, and their duplicated description will be omitted. The suffixes “module” and “part” for components used in the description below are assigned or mixed in consideration of easiness in writing the specification and do not have distinctive meanings or roles by themselves. Moreover, detailed descriptions related to well-known functions or configurations will be ruled out in order not to unnecessarily obscure subject matters of the present disclosure. However, this does not limit the present disclosure within specific embodiments and it should be understood that the present disclosure covers all the modifications, equivalents, and replacements within the idea and technical scope of the present disclosure.

It will be understood that although the ordinal numbers such as first and second are used herein to describe various elements, these elements should not be limited by these numbers. The terms are only used to distinguish one component from other components.

It will also be understood that when an element is referred to as being “‘connected to” or “engaged with” another element, it can be directly connected to the other element, or intervening elements can also be present. It will also be understood that when an element is referred to as being ‘directly connected to’ another element, there is no intervening elements.

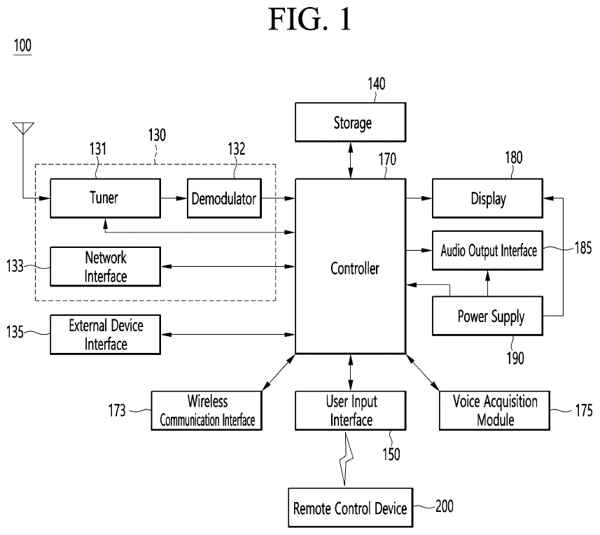

FIG. 1 is a block diagram illustrating a configuration of a display device according to an embodiment of the present disclosure.

Referring to FIG. 1, a display device 100 may include a broadcast reception module 130, an external device interface unit 135, a storage unit 140, a user input unit 150, a control unit 170, a wireless communication interface unit 173, a display unit 180, an audio output unit 185, and a power supply unit 190.

The broadcast reception module 130 may include a tuner 131, a demodulator 132, and a network interface 133.

The tuner 131 may select a specific broadcast channel according to a channel selection command. The tuner 131 may receive broadcast signals for the selected specific broadcast channel.

The demodulation unit 132 may divide the received broadcast signals into video signals, audio signals, and broadcast program-related data signals, and may restore the divided video signals, audio signals, and data signals into an output available form.

The network interface 133 may provide an interface for connecting the display device 100 to a wired/wireless network comprising internet network. The network interface 133 may transmit or receive data to or from another user or another electronic device through an accessed network or another network linked to the accessed network.

The network interface unit 133 may access a predetermined webpage through an accessed network or another network linked to the accessed network. That is, the network interface unit 133 may transmit or receive data to or from a corresponding server by accessing a predetermined webpage through the network.

The network interface unit 133 may receive content or data provided from a content provider or a network operator. That is, the network interface unit 133 may receive content, such as movies, advertisements, games, VODs, and broadcast signals, which are provided from the content provider or the network operator, and information relating thereto through the network.

In addition, the network interface unit 133 may receive firmware update information and update files provided from the network operator, and may transmit data to the Internet or content provider or the network operator.

The network interface 133 may select and receive a desired application among applications open to the air, through network.

The external device interface unit 135 may receive an application or an application list in an adjacent external device and deliver the application or the application list to the control unit 170 or the storage unit 140.

The external device interface unit 135 may provide a connection path between the display device 100 and an external device. The external device interface unit 135 may receive at least one of an image or audio outputted from an external device that is wirelessly or wiredly connected to the display device 100 and deliver the received image or the audio to the controller. The external device interface unit 135 may include a plurality of external input terminals. The plurality of external input terminals may include an RGB terminal, at least one High Definition Multimedia Interface (HDMI) terminal, and a component terminal.

An image signal of an external device inputted through the external device interface unit 135 may be outputted through the display unit 180. A sound signal of an external device inputted through the external device interface unit 135 may be outputted through the audio output unit 185.

An external device connectable to the external device interface unit 135 may be one of a set-top box, a Blu-ray player, a DVD player, a game console, a sound bar, a smartphone, a PC, a USB Memory, and a home theater system but this is just exemplary.

Additionally, some content data stored in the display device 100 may be transmitted to a user or an electronic device, which is selected from other users or other electronic devices pre-registered in the display device 100.

The storage unit 140 may store signal-processed image, voice, or data signals stored by a program in order for each signal processing and control in the control unit 170.

In addition, the storage unit 140 may perform a function for temporarily storing image, voice, or data signals output from the external device interface unit 135 or the network interface unit 133, and may store information on a predetermined image through a channel memory function.

The storage unit 140 may store an application or an application list input from the external device interface unit 135 or the network interface unit 133.

The display device 100 may play content files (e.g., video files, still image files, music files, document files, application files, etc.) stored in the storage unit 140, and may provide the content files to a user.

The user input unit 150 may transmit signals input by a user to the control unit 170, or may transmit signals from the control unit 170 to a user. For example, the user input unit 150 may receive or process control signals such as power on/off, channel selection, and screen setting from the remote control device 200 or transmit control signals from the control unit 170 to the remote control device 200 according to various communication methods such as Bluetooth, Ultra Wideband (WB), ZigBee, Radio Frequency (RF), and IR communication methods.

In addition, the user input unit 150 may transmit, to the control unit 170, control signals input from local keys (not shown) such as a power key, a channel key, a volume key, and a setting key.

Image signals that are image-processed by the control unit 170 may be input to the display unit 180 and displayed as images corresponding to the image signals. In addition, image signals that are image-processed by the control unit 170 may be input to an external output device through the external device interface unit 135.

Voice signals processed by the control unit 170 may be output to the audio output unit 185. In addition, voice signals processed by the control unit 170 may be input to the external output device through the external device interface unit 135.

Additionally, the control unit 170 may control overall operations of the display device 100.

In addition, the control unit 170 may control the display device 100 by a user command or an internal program input through the user input unit 150, and may access the network to download a desired application or application list into the display device 100.

The control unit 170 may output channel information selected by a user together with the processed image or voice signals through the display unit 180 or the audio output unit 185.

In addition, the control unit 170 may output image signals or voice signals of an external device such as a camera or a camcorder, which are input through the external device interface unit 135, through the display unit 180 or the audio output unit 185, according to an external device image playback command received through the user input unit 150.

Moreover, the control unit 170 may control the display unit 180 to display images, and may control the display unit 180 to display broadcast images input through the tuner 131, external input images input through the external device interface unit 135, images input through the network interface unit, or images stored in the storage unit 140. In this case, an image displayed on the display unit 180 may be a still image or video and also may be a 2D image or a 3D image.

Additionally, the control unit 170 may play content stored in the display device 100, received broadcast content, and external input content input from the outside, and the content may be in various formats such as broadcast images, external input images, audio files, still images, accessed web screens, and document files.

Moreover, the wireless communication unit 173 may perform wired or wireless communication with an external device. The wireless communication unit 173 may perform short-range communication with an external device. For this, the wireless communication unit 173 may support short-range communication by using at least one of Bluetooth™, Bluetooth Low Energy (BLE), Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication unit 173 may support wireless communication between the display device 100 and a wireless communication system, between the display device 100 and another display device 100, or between networks including the display device 100 and another display device 100 (or an external server) through wireless area networks. The wireless area networks may be wireless personal area networks.

Herein, the other display device 100 may be a mobile terminal such as a wearable device (for example, a smart watch, a smart glass, and a head mounted display (HMD)) or a smartphone, which is capable of exchanging data (or inter-working) with the display device 100. The wireless communication unit 173 may detect (or recognize) a wearable device capable of communication around the display device 100. Furthermore, if the detected wearable device is a device authenticated to communicate with the display device 100, the control unit 170 may transmit at least part of data processed in the display device 100 to the wearable device through the wireless communication unit 173. Therefore, a user of the wearable device may use the data processed by the display device 100 through the wearable device.

The voice acquisition unit 175 may acquire audio. The voice acquisition unit 175 may include at least one microphone (not shown) and may acquire audio around the display device 100 through the microphone (not shown).

The display unit 180 may convert image signals, data signals, or on-screen display (OSD) signals, which are processed in the control unit 170, or images signals or data signals, which are received in the external device interface unit 135, into R, G, and B signals to generate driving signals.

Furthermore, the display device 100 shown in FIG. 1 is just one embodiment of the present disclosure and thus, some of the components shown may be integrated, added, or omitted according to the specification of the actually implemented display device 100.

That is, if necessary, two or more components may be integrated into one component, or one component may be divided into two or more components. Additionally, a function performed by each block is to describe an embodiment of the present disclosure and its specific operation or device does not limit the scope of the present disclosure.

According to another embodiment of the present disclosure, unlike FIG. 1, the display device 100 may receive images through the network interface unit 133 or the external device interface unit 135 and play them without including the tuner 131 and the demodulation unit 132.

For example, the display device 100 may be divided into an image processing device such as a set-top box for receiving broadcast signals or contents according to various network services and a content playback device for playing content input from the image processing device.

In this case, an operating method of a display device according to an embodiment of the present disclosure described below may be performed by one of the display device described with reference to FIG. 1, an image processing device such as the separated set-top box, and a content playback device including the display unit 180 and the audio output unit 185.

The audio output unit 185 receives the audio-processed signal from the control unit 170 to output an audio signal.

The power supply unit 190 supplies the corresponding power to the entire display device 100. Particularly, power may be supplied to the control unit 170 that is capable of being implemented in the form of a system on chip (SOC), the display unit 180 for displaying an image, the audio output unit 185 for outputting audio, and the like.

Specifically, the power supply unit 190 may include a converter that converts AC power to DC power and a DC/DC converter that converts a level of the DC power.

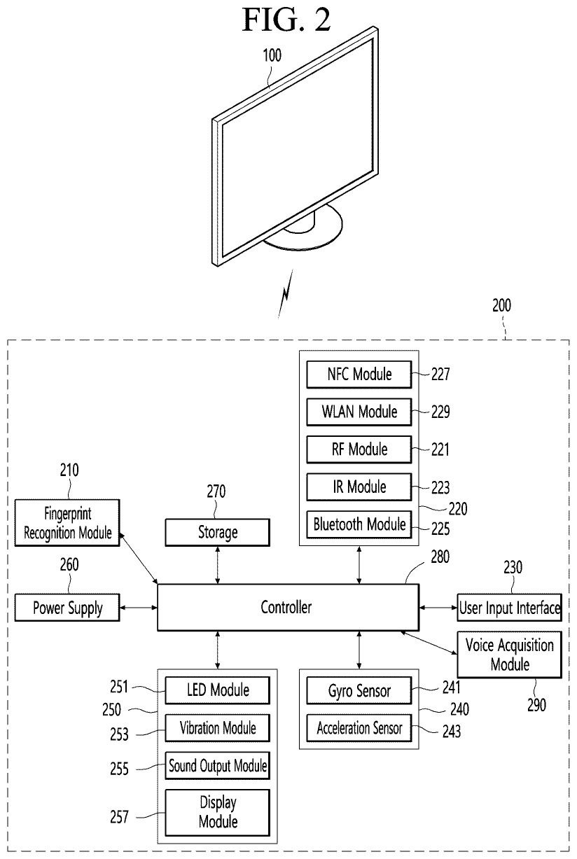

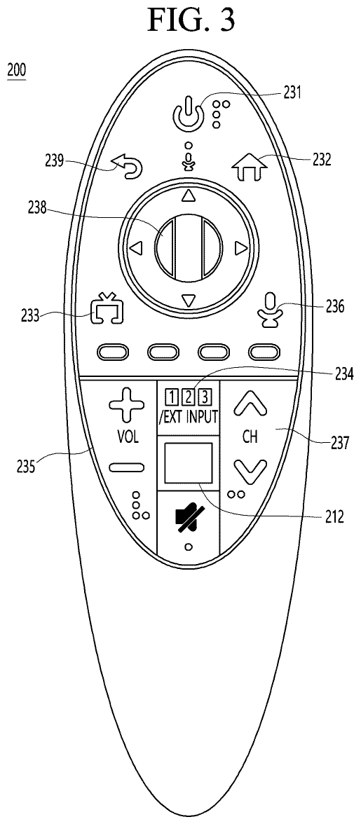

A remote control device according to an embodiment of the present disclosure will be described with reference to FIGS. 2 and 3.

FIG. 2 is a block diagram illustrating a remote control device according to an embodiment of the present disclosure and FIG. 3 is a view illustrating an actual configuration of a remote control device according to an embodiment of the present disclosure.

First, referring to FIG. 2, a remote control device 200 may include a fingerprint recognition unit 210, a wireless communication unit 220, a user input unit 230, a sensor unit 240, an output unit 250, a power supply unit 260, a storage unit 270, a control unit 280, and a sound acquisition unit 290.

Referring to FIG. 2, the wireless communication unit 220 transmits/receives signals to/from an arbitrary any one of display devices according to the above-mentioned embodiments of the present disclosure.

The remote control device 200 may include a radio frequency (RF) module 221 capable of transmitting or receiving signals to or from the display device 100 according to an RF communication standard, and an IR module 223 capable of transmitting or receiving signals to or from the display device 100 according to an IR communication standard. In addition, the remote control device 200 may include a Bluetooth module 225 capable of transmitting or receiving signals to or from the display device 100 according to a Bluetooth communication standard. In addition, the remote control device 200 may include an NFC module 227 capable of transmitting or receiving signals to or from the display device 100 according to an NFC communication standard, and a wireless LAN (WLAN) module 229 capable of transmitting or receiving signals to or from the display device 100 according to a WLAN communication standard.

In addition, the remote control device 200 may transmit signals containing information on the movement of the remote control device 200 to the display device 100 through the wireless communication unit 220.

Moreover, the remote control device 200 may receive signals transmitted from the display device 100 through the RF module 221 and if necessary, may transmit a command for power on/off, channel change, and volume change to the display device 100 through the IR module 223.

The user input unit 230 may be configured with a keypad, a button, a touch pad, or a touch screen. A user may operate the user input unit 230 to input a command relating to the display device 100 to the remote control device 200. If the user input unit 230 includes a hard key button, a user may input a command relating to the display device 100 to the remote control device 200 through the push operation of the hard key button. This will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back button 239.

The fingerprint recognition button 212 may be a button for recognizing a user's fingerprint. According to an embodiment of the present disclosure, the fingerprint recognition button 212 may perform a push operation and receive a push operation and a fingerprint recognition operation. The power button 231 may be a button for turning on/off the power of the display device 100. The home button 232 may be a button for moving to the home screen of the display device 100. The live button 233 may be a button for displaying live broadcast programs. The external input button 234 may be a button for receiving an external input connected to the display device 100. The volume control button 235 may be a button for controlling a volume output from the display device 100. The voice recognition button 236 may be a button for receiving user's voice and recognizing the received voice. The channel change button 237 may be a button for receiving broadcast signals of a specific broadcast channel. The OK button 238 may be a button for selecting a specific function, and the back button 239 may be a button for returning to a previous screen.

FIG. 2 is described again.

If the user input unit 230 includes a touch screen, a user may touch a soft key of the touch screen to input a command relating to the display device 100 to the remote control device 200. In addition, the user input unit 230 may include various kinds of input interfaces operable by a user, for example, a scroll key and a jog key, and this embodiment does not limit the scope of the present disclosure.

The sensor unit 240 may include a gyro sensor 241 or an acceleration sensor 243. The gyro sensor 241 may sense information on the movement of the remote control device 200.

For example, the gyro sensor 241 may sense information on an operation of the remote control device 200 on the basis of x, y, and z axes and the acceleration sensor 243 may sense information on a movement speed of the remote control device 200. Moreover, the remote control device 200 may further include a distance measurement sensor that senses a distance with respect to the display unit 180 of the display device 100.

The output unit 250 may output image or voice signals in response to the operation of the user input unit 230, or may output image or voice signals corresponding to signals transmitted from the display device 100. A user may recognize whether the user input unit 230 is operated or the display device 100 is controlled through the output unit 250.

For example, the output unit 250 may include an LED module 251 for flashing, a vibration module 253 for generating vibration, a sound output module 255 for outputting sound, or a display module 257 for outputting an image, if the user input unit 230 is manipulated or signals are transmitted/received to/from the display device 100 through the wireless communication unit 220.

Additionally, the power supply unit 260 supplies power to the remote control device 200 and if the remote control device 200 does not move for a predetermined time, stops the power supply, so that power waste may be reduced. The power supply unit 260 may resume the supply of power if a predetermined key provided at the remote control device 200 is operated.

The storage unit 270 may store various kinds of programs and application data required to control or operate the remote control device 200. If the remote control device 200 transmits/receives signals wirelessly through the display device 100 and the RF module 221, the remote control device 200 and the display device 100 transmits/receives signals through a predetermined frequency band.

The control unit 280 of the remote control device 200 may store, in the storage unit 270, information on a frequency band for transmitting/receiving signals to/from the display device 100 paired with the remote control device 200 and refer to it.

The control unit 280 controls general matters relating to the control of the remote control device 200. The control unit 280 may transmit a signal corresponding to a predetermined key operation of the user input unit 230 or a signal corresponding to the movement of the remote control device 200 sensed by the sensor unit 240 to the display device 100 through the wireless communication unit 220.

In addition, the sound acquisition unit 290 of the remote control device 200 may acquire voice.

The sound acquisition unit 290 may include at least one microphone and acquire voice through the microphone.

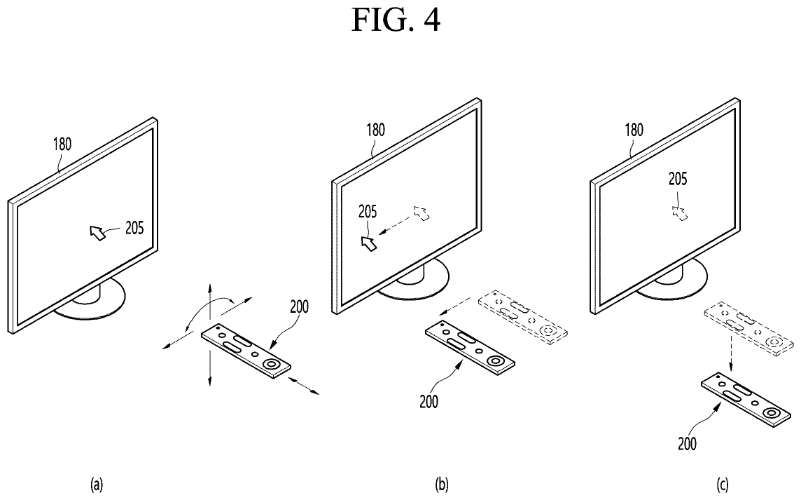

Next, FIG. 4 is described.

FIG. 4 is a view illustrating an example of utilizing a remote control device according to an embodiment of the present disclosure.

FIG. 4(a) illustrates that a pointer 205 corresponding to the remote control device 200 is displayed on the display unit 180.

A user may move or rotate the remote control device 200 vertically or horizontally. The pointer 205 displayed on the display unit 180 of the display device 100 corresponds to a movement of the remote control device 200. Since the corresponding pointer 205 is moved and displayed according to a movement on a 3D space as shown in the drawing, the remote control device 200 may be referred to as a spatial remote control device.

FIG. 4(b) illustrates that if a user moves the remote control device 200, the pointer 205 displayed on the display unit 180 of the display device 100 is moved to the left according to the movement of the remote control device 200.

Information on a movement of the remote control device 200 detected through a sensor of the remote control device 200 is transmitted to the display device 100. The display device 100 may calculate the coordinates of the pointer 205 from the information on the movement of the remote control device 200. The display device 100 may display the pointer 205 to match the calculated coordinates.

FIG. 4(c) illustrates that while a specific button in the remote control device 200 is pressed, a user moves the remote control device 200 away from the display unit 180. Thus, a selected region in the display unit 180 corresponding to the pointer 205 may be zoomed in and displayed in an enlarged size.

On the other hand, if a user moves the remote control device 200 close to the display unit 180, a selection area in the display unit 180 corresponding to the pointer 205 may be zoomed out and displayed in a reduced size.

On the other hand, if the remote control device 200 is moved away from the display unit 180, a selection area may be zoomed out and if the remote control device 200 is moved closer to the display unit 180, a selection area may be zoomed in.

Additionally, if a specific button in the remote control device 200 is pressed, recognition of a vertical or horizontal movement may be excluded. That is, if the remote control device 200 is moved away from or closer to the display unit 180, the up, down, left, or right movement cannot be recognized and only the back and forth movement may be recognized. While a specific button in the remote control device 200 is not pressed, only the pointer 205 is moved according to the up, down, left or right movement of the remote control device 200.

Moreover, the moving speed or moving direction of the pointer 205 may correspond to the moving speed or moving direction of the remote control device 200.

Furthermore, a pointer in this specification means an object displayed on the display unit 180 in response to an operation of the remote control device 200. Therefore, in addition to the arrow form displayed as the pointer 205 in the drawing, various forms of objects are possible. For example, the above concept includes a point, a cursor, a prompt, and a thick outline. Then, the pointer 205 may be displayed in correspondence to one point of a horizontal axis and a vertical axis on the display unit 180 and also may be displayed in correspondence to a plurality of points such as a line and a surface.

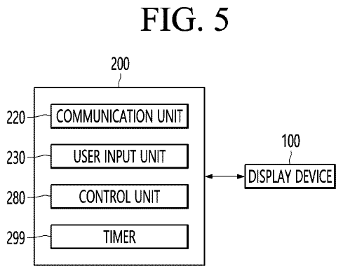

FIG. 5 is a view for explaining a control operation of the display device of the remote control device according to an embodiment of the present disclosure.

As illustrated in FIG. 5, the remote control device 200 that controls the display device 100 according to the present disclosure may include a communication unit 220, a user input unit 230 including a plurality of user buttons, and a control unit 280 for controlling the communication unit 220 to transmit a screen information control signal corresponding to a user button.

In addition, the remote control device 200 may further include a timer 299 that measures s press time of the user button.

Here, the control unit 280 may control the timer 299 to measure a press time of a specific button when the specific button of a plurality of user buttons is pressed.

Next, the control unit 280 may measure the press time of the specific button when the specific button of the plurality of user buttons is pressed, transmits a screen information control signal containing button data to the display device 100 when the press time of the specific button is shorter than a first set time, and transmit the screen information control signal containing scroll data to the display device 100 when the press time of the specific button exceeds the first set time.

Here, the screen information control signal may be input as a data packet including payload data having a button data area and a scroll data area.

For example, the button data area may include button data having a radio frequency (RF) key code, and the scroll data area may include scroll data having a scroll value.

Next, the control unit 280 may transmit a screen information control signal, in which the button data is contained in the button data area, and the scroll data is not contained in the scroll data area, to the display device 100 to perform a main function of the specific button when the press time of the specific button is less than or equal to the first set time.

Here, the control unit 280 may transmit a screen information control signal containing the button data to the display device 100 so that the main function of the specific button, which moves the screen information of the display device 100 in vertical and horizontal directions, is performed when the specific button is a navigation button.

In addition, the control unit 280 may transmit a screen information control signal, in which the button data is not contained in the button data area, and the scroll data is contained in the scroll data area, to the display device 100 to perform the scroll function of the specific button when the press time of the specific button exceeds the first set time.

For example, the control unit 280 may transmit a screen information control signal containing scroll data to the display device 100 to perform the scroll function of the specific button that performs scrolls up/down or pages up/down of the screen information of the display device 100 when the specific button is the navigation button.

Next, the control unit 280 may transmit a screen information control signal, in which the button data is not contained in the button data area, and the scroll data is not contained in the scroll data area, to the display device 100 when the specific button is released.

In addition, the control unit 280 may transmit the screen information control signal, in which the button data is not contained in the button data area, and the scroll data is not contained in the scroll data area, to the display device 100 when the press time of the specific button reaches the first set time.

In addition, the control unit 280 may transmit the screen information control signal, in which the button data is not contained in the button data area, and the scroll data is not contained in the scroll data area, to the display device 100 immediately before transmitting the screen information control signal in which the scroll data is contained in the scroll data area.

Next, the control unit 280 may confirm a pressed state of the specific button at a second set time interval after transmitting the screen information control signal, in which the scroll data is contained in the scroll data area, to the display device 100 and repeatedly transmit the screen information control signal, in which the scroll data is contained in the scroll data area, to the display device 100 so that the scroll function of the specific button is performed when the pressed state of the specific button continues.

Here, the control unit 280 may confirm the pressed state of the specific button at the second set time interval and transmit the screen information control signal, in which the button data is contained in the button data area, to the display device 100 to perform the main function of the specific button when the pressed state of the specific button is ended.

Here, the second set time may be shorter than the first set time.

For example, the second set time may be 400 ms to 600 ms, and the first set time may be 50 ms to 200 ms, but this is only an example and is not limited thereto.

In addition, the specific button of the remote control device 200 may include the navigation button that requests an operation for moving the screen information of the display device 100 in the vertical and horizontal directions, but this is only an example and is not limited thereto, and thus, the specific button may be any one of the plurality of user buttons.

When one of the plurality of user buttons is selected as the specific button, the scroll function may be added together with a unique function of the specific button.

That is, in the present disclosure, the button data or the scroll data may be contained in the data packet of the screen control signal corresponding to the specific button on the basis of the press time of the specific button to perform the unique function and the scroll function of the specific button.

Next, the control unit 280 may transmit a plurality of screen information control signals, which contain the same button data and do not contain the scroll data, to the display device 100 at a first time interval when the press time of the specific button is less than or equal to a first set time and transmit a screen information control signal, which does not contain the button data and contains the scroll data, to the display device 100 at a second time interval when the press time of the specific button exceeds the first set time.

Here, the first time interval may be shorter than the second time interval.

In addition, the control unit 280 may transmit the screen information control signal to the display device 100 for the first set time so that the display device 100 generates and displays a guide message for activating the scroll function on the basis of the screen information control signal.

Here, the screen information control signal may not contain the button data within the button data area and may not contain the scroll data within the scroll data area.

For example, the display device 100 may generate and output the guide message including a content, in which the scroll function is activated when the specific button of the remote control device 200 is pressed for a long time, into at least one of text, voice, and video formats.

Next, the control unit 280 may transmit the screen information control signal containing the scroll data to the display device 100 so that the display device 100 generates and displays a notification message for notifying start of the activation of the scroll function of the specific button.

Here, the display device 100 may generate and output the notification message into at least one of text, voice, and image formats to notify the start of the activation of the scroll function for the specific button of the remote control device 200.

In addition, the display device 100 may generate and display a scroll indicator together with the providing of the notification message.

When the screen information control signal corresponding to the specific button of the remote control device 200 is input, the display device 100 may scroll the screen information corresponding to the scroll data if the screen information control signal does not contain the button data and only contains the scroll data and may process the screen information corresponding to the button data if the screen information control signal does not contain the scroll data and only contains the button data.

In some cases, the display device 100 may confirm whether the screen information control signal corresponding to the specific button of the remote control device 200 is input for a preset period of time, confirm whether the scroll data is contained in the screen information control signal corresponding to the specific button after the preset period of time is elapsed when the screen information control signal is input for the preset period of time, and scroll the screen information can be scrolled in response to the scroll data when the screen information control signal contains scroll data.

Here, the display device 100 may recognize a time point, at which the screen information control signal that does not contain the button data is input, as a time point at which the preset time has arrived when one screen information control signal containing the button data corresponding to a specific button of the remote control device 200 is input during the preset time, and then, the screen information control signal that does not contain the button data corresponding to the specific button is input.

In addition, the display device 100 may generate and output the guide message including a content, in which the scroll function is activated when the specific button of the remote control device 200 is pressed for a long time, into at least one of text, voice, and video formats.

Next, the display device 100 may confirm whether the scroll data is contained in the screen information control signal after the preset time is elapsed when the plurality of screen information control signals containing the same button data corresponding to the specific button of the remote control device 200 are continuously input for a preset time.

Here, the screen control signal corresponding to the specific button of the remote control device 200 may be a data packet including payload data having a button data area and a scroll data area, and also, the button data area may include button data having a radio frequency (RF) key code, and the scroll data area may not include scroll data having a scroll value.

Here, the display device 100 may recognize a time point, at which the screen information control signal that does not contain the button data is input, as a time point at which the preset time has arrived when the plurality of screen information control signals containing the same button data corresponding to the specific button of the remote control device is input during the preset time, and then, the screen information control signal that does not contain the button data corresponding to the specific button is input.

Here, the display device 100 may recognize that a preset time has arrived when the screen information control signal that does not contain the button data corresponding to the specific button is input, and then may confirm whether the scroll data is contained in the screen information control signal that does not contain the button data corresponding to the specific button.

Next, the display device 100 may generate and provide the notification message for notifying the start of the activation of the scroll function of the specific button when the screen control signal corresponding to the specific button of the remote control device 200 is input, and the preset time is elapsed.

Here, the display device 100 may generate and output the notification message into at least one of text, voice, and image formats to notify the start of the activation of the scroll function for the specific button of the remote control device 200.

In addition, the display device 100 may generate a scroll indicator together with the providing of the notification message to display the scroll indicator.

In addition, when the screen information control signal corresponding to the specific button is input after the preset time is elapsed, the display device 100 may confirm payload data having the button data area and the scroll data area among the data packets of the screen control signal, and may scroll the screen information corresponding to the scroll data when the button data area does not contain the button data, and the scroll data area contains the scroll data.

Here, the display device 100 may scroll the screen information in an up direction when the scroll data is command data instructing a scroll up operation and may scroll the screen information in a down direction when the scroll data is command data instructing a scroll down operation.

Next, when scrolling the screen information having a plurality of pages, the display device 100 may move the current page of the screen information in the up direction when the scroll data is command data instructing the scroll up operation, switch the current page to a previous page of the screen information when the previous page of the screen information exists, and refresh the current page of the screen information when the previous page of the screen information does not exist.

Next, when scrolling the screen information having a plurality of pages, the display device 100 may move the current page of the screen information in the down direction when the scroll data is command data instructing the scroll down operation, switch the current page to a next page of the screen information when the next page of the screen information exists, and refresh the current page of the screen information when the next page of the screen information does not exist.

In addition, when scrolling the screen information, in a state in which a cursor displayed on the display screen is disposed within an address window of the screen information, if a scroll function of the specific button is activated on the basis of the screen information control signal corresponding to the specific button of the remote control device 200, the display device 100 may display a user's access history around the address window and scroll the screen information to move to a corresponding access page according to the access history.

Here, the display device 100 may sort the corresponding access pages in any one of the following order: most sympathy, most latest, or most sympathy ratio when scrolling the screen information and then sequentially scroll the sorted access pages.

As described above, the remote control device may generate the screen information control signal containing the scroll data on the basis of the press time of the specific button to transmit the screen information control signal to the display device, thereby controlling the scroll operation of the screen information displayed on the display device while maintaining existing usability by using the replacement button instead of the wheel button, and thus, a defect rate due to the removal of the wheel button may be improved, user convenience may be improved, and a slim design may be enabled.

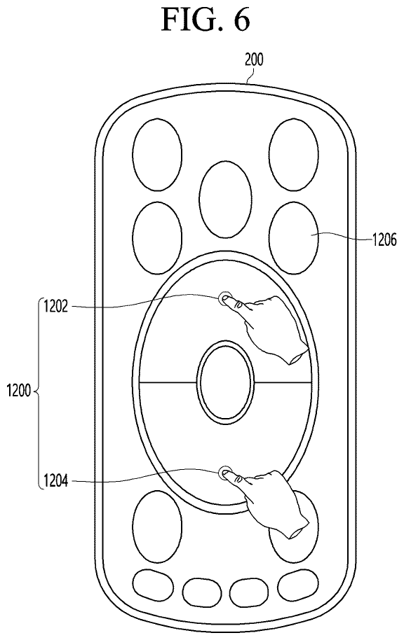

FIG. 6 is a view for explaining the user input for generating the scroll data of the remote control device according to an embodiment of the present disclosure.

As illustrated in FIG. 6, the specific button of the remote control device may include a navigation button 1200 that requests an operation for moving the screen information of the display device in the vertical and horizontal directions, but this is only an example and is not limited thereto, and thus, the specific button may be any one of a plurality of user buttons 1206.

When one of the plurality of user buttons 1206 is selected as the specific button, the scroll function may be added together with a unique function of the specific button.

That is, in the present disclosure, the button data or the scroll data may be contained in the data packet of the screen control signal corresponding to the specific button on the basis of the press time of the specific button to perform the unique function and the scroll function of the specific button.

For example, in the present disclosure, when a press time of an up button 1202 of the navigation buttons 1200 exceeds a set time, the screen information control signal, which does not contain the button data and contains only the scroll data, may be transmitted to the display device to scroll the screen information of the display device in the up direction.

In addition, in the present disclosure, when the press time of the up button 1202 of the navigation buttons 1200, the screen information control signal, which contains only the button data and does not contain the scroll data, may be transmitted to the display device to move a selection item for the screen information of the display device in the up direction.

For another example, in the present disclosure, when a press time of a down button 1204 of the navigation buttons 1200 exceeds a set time, the screen information control signal, which does not contain the button data and contains only the scroll data, may be transmitted to the display device to scroll a selection item for the screen information of the display device in the down direction.

In addition, in the present disclosure, when the press time of the down button 1204 of the navigation buttons 1200 is less than or equal to the set time, the screen information control signal, which contains only the button data and does not contain the scroll data, may be transmitted to the display device to move a selection item for the screen information of the display device in the down direction.

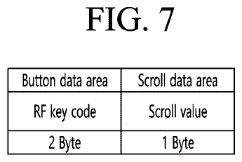

FIG. 7 is a view for explaining a data packet structure of the screen information control signal according to an embodiment of the present disclosure.

As illustrated in FIG. 7, the remote control device of the present disclosure may include the button data or the scroll data in the data packet of the screen control signal corresponding to the specific button on the basis of the press time of the specific button to operate the unique function and the scroll function of the specific button.

Here, the screen information control signal may be input as a data packet including payload data having a button data area and a scroll data area.

For example, the button data area may include button data having a radio frequency (RF) key code, and the scroll data area may include scroll data having a scroll value.

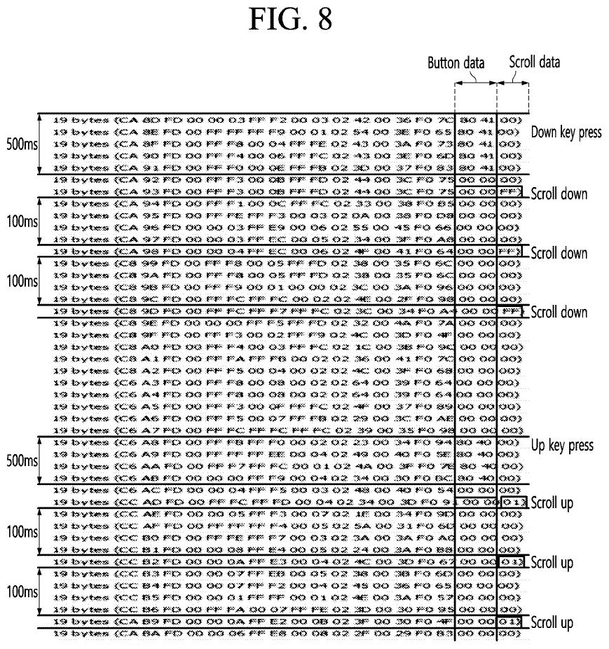

FIG. 8 is a view for explaining a data pocket structure of a screen information control signal corresponding to a specific button press time of the remote control device according to an embodiment of the present disclosure.

As illustrated in FIG. 8, in the present disclosure, the screen information control signal, which contains only the button data and does not the scroll data, may be transmitted to the display device when a press time of a down key of the navigation button is less than or equal to a first set time that is about 500 ms.

In addition, in the present disclosure, when the press time of the down key of the navigation button reaches the first set time of about 500 ms, the screen information control signal that does not contain the button data and scroll data may be transmitted to the display device, and when the press time of the down key of the navigation button exceeds the first set time of about 500 ms, the screen information control signal that does not contain the button data and contains only the scroll data may be transmitted to the display device to perform the scroll down the screen information.

Next, in the present disclosure, after transmitting the screen information control signal, which contains the scroll data within the scroll data area, to the display device, a pressed state of the down key may be confirmed as a state of the down key at intervals of 100 ms, which is a second set time, and when the pressed state of the down key continues, the screen information control signal, which does not contain the button data and contains only the scroll data, may be repeatedly transmitted to the display device to continuously perform the scroll down of the screen information.

In addition, in the present disclosure, the screen information control signal, which contains only the button data and does not the scroll data, may be transmitted to the display device when a press time of an up key of the navigation button is less than or equal to a first set time that is about 500 ms.

In addition, in the present disclosure, when the press time of the up key of the navigation button reaches the first set time of about 500 ms, the screen information control signal that does not contain the button data and scroll data may be transmitted to the display device, and when the press time of the up key of the navigation button exceeds the first set time of about 500 ms, the screen information control signal that does not contain the button data and contains only the scroll data may be transmitted to the display device to perform the scroll up the screen information.

Next, in the present disclosure, after transmitting the screen information control signal, which contains the scroll data within the scroll data area, to the display device, a pressed state of the up key may be confirmed as a state of the up key at intervals of 100 ms, which is a second set time, and when the pressed state of the down key continues, the screen information control signal, which does not contain the button data and contains only the scroll data, may be repeatedly transmitted to the display device to continuously perform the scroll up of the screen information.

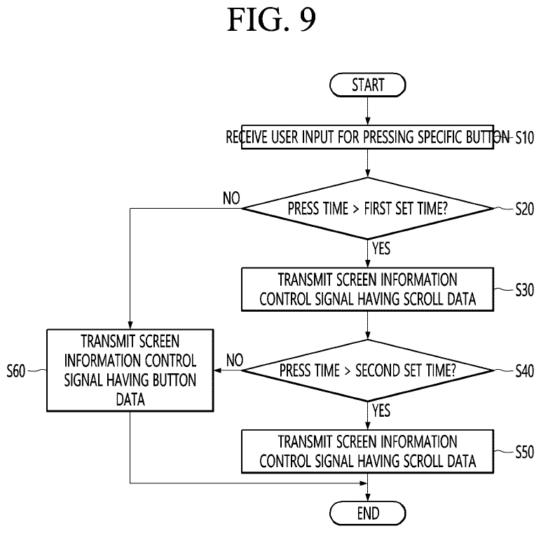

FIG. 9 is a flowchart for explaining an operation of the remote control device according to an embodiment of the present disclosure.

As illustrated in FIG. 9, in the present disclosure, a user input of pressing a specific button of a plurality of user buttons may be received (S10).

Next, in the present disclosure, when the user input for pressing the specific button is received, a press time of the specific button may be measured to confirm whether the press time of the specific button exceeds a first set time (S20).

Here, in the present disclosure, when the press time of the specific button is less than or equal to the first set time, a screen information control signal, which contains button data and does not contain scroll data, may be transmitted to the display device to perform a main function of the specific button (S60).

Next, in the present disclosure, when the press time of the specific button exceeds the first set time, a screen information control signal, which contains the scroll data, may be transmitted to the display device (S30).

Here, in the present disclosure, a screen information control signal, which contains the scroll data and does not contain the button data, may be transmitted to the display device to perform a scroll function of the specific button.

In addition, in the present disclosure, the press time of the specific button may be measured to determine whether the press time of the specific button exceeds a second set time (S40).

Here, in the present disclosure, when the press time of the specific button is less than or equal to the second set time, a screen information control signal, which contains button data and does not contain scroll data, may be transmitted to the display device to perform the main function of the specific button (S60).

In addition, in the present disclosure, when measuring the press time of the specific button, the press time of the specific button may be measured at a time point at which the screen information control signal, which contains the scroll data, is transmitted to the display device.

Next, in the present disclosure, when the press time of the specific button exceeds the second set time, a screen information control signal, which contains the scroll data, may be transmitted to the display device (S50).

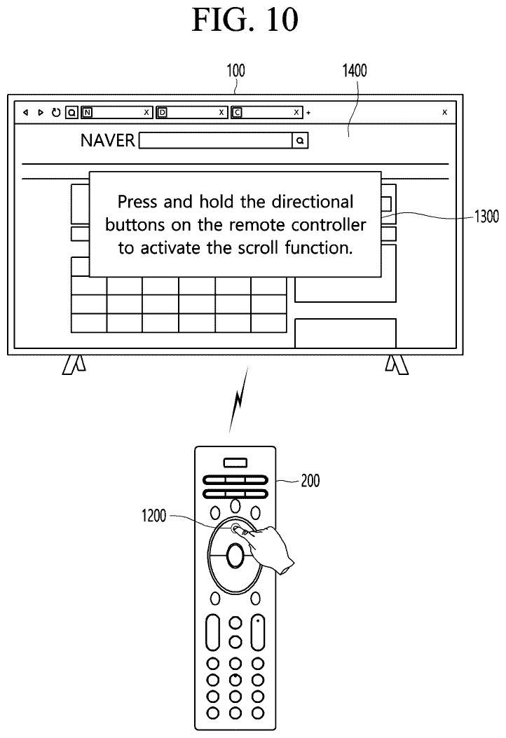

FIG. 10 is a view for explaining a guide message for activating the scroll function of the remote control device according to an embodiment of the present disclosure.

As illustrated in FIG. 10, a remote control device 200 of the present disclosure may transmit a screen information control signal, which contains button data and does not contain scroll data, to the display device 100 to perform a main function of a specific button 1200 when a press time of the specific button 1200 is less than or equal to a set time.

In addition, the display device 100 may recognize the specific button 1200 having the scroll function on the basis of the received screen information control signal, and display a guide message 1300 including a content, in which the scroll function is activated when the specific button 1200 of the remote control device 200 is pressed for a long time, on the screen information 1400.

Here, the display device 100 may generate and output a guide message 1300 in at least one of text, voice, and image formats.

For example, the display device 100 may recognize the screen control signal corresponding to the specific button having a scroll function on the basis of the button data, which is contained in the screen control signal, and output the guide message 1300 including the content, in which the scroll function is activated when the specific button is pressed for a long time, to provide user convenience.

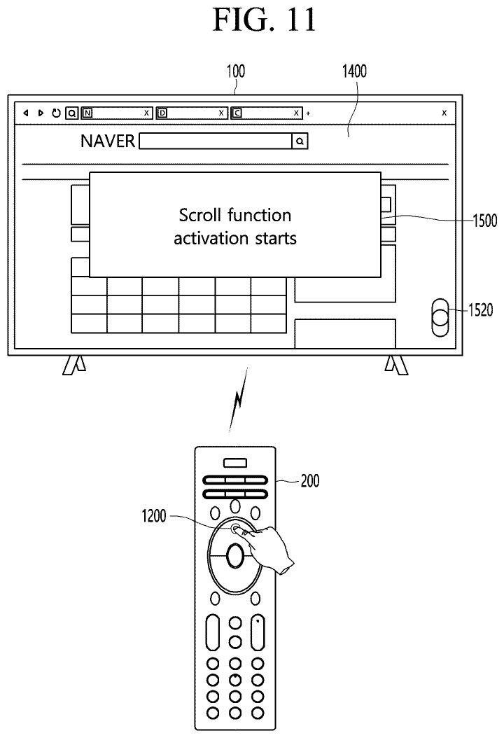

FIG. 11 is a view for explaining a notification message for notifying start of the activation of the scroll function of the remote control device according to an embodiment of the present disclosure.

As illustrated in FIG. 11, the remote control device 200 of the present disclosure may transmit the screen information control signal, which contains the button data and does not contain the scroll data, to the display device 100 to perform the main function of the specific button 1200 when the press time of the specific button 1200 is less than or equal to the set time.

In addition, when the press time of the specific button 1200 exceeds the set time, the remote control device 200 of the present disclosure may transmit the screen information control signal, which does not contain the button data and contains the scroll data, to the display device 100 to perform the scroll function of the specific button 1200.

Next, when receiving the screen information control signal containing the scroll data, the display device 100 may generate a notification message 1500 for notifying start of activation of the scroll function of the specific button 1200 to display the notification message 1500 on the screen information 1400.

Here, the display device 100 may generate and output the notification message 1500 into at least one of text, voice, and image formats to notify the start of the activation of the scroll function for the specific button 1200 of the remote control device 200.

In addition, the display device 100 may generate and display a scroll indicator 1520 together with the providing of the notification message 1500.

Here, the scroll indicator 1520 may serve to provide user convenience by distinguishing the scroll up and scroll down operations from each other so that the user easily recognizes the scroll up and scroll down operations.

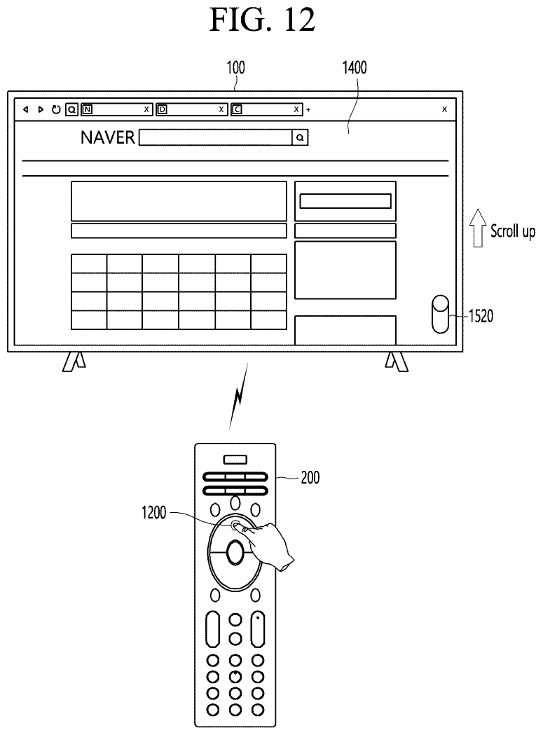

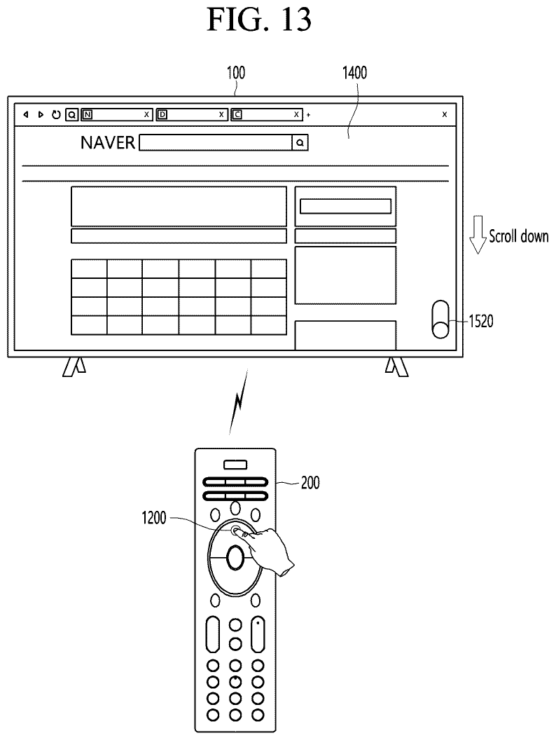

FIGS. 12 and 13 are views for explaining the scroll indicator corresponding to the scroll operation of the display device according to an embodiment of the present disclosure.

As illustrated in FIGS. 12 and 13, when the screen information control signal corresponding to the specific button 1200 of the remote control device 200 is input after the preset time is elapsed, the display device 100 may confirm payload data having the button data area and the scroll data area among the data packets of the screen control signal, and may scroll the screen information 1400 corresponding to the scroll data when the button data area does not contain the button data, and the scroll data area contains the scroll data.

Here, the display device 100 may scroll the screen information 1400 in an up direction when the scroll data is command data instructing the scroll up operation as illustrated in FIG. 12, and may scroll the screen information 1400 in a down direction when the scroll data is command data instructing the scroll down operation as illustrated in FIG. 13.

Here, the scroll indicator 1520 may display the identifier as the scroll up when the display device 100 performs the scroll up operation as illustrated in FIG. 12, and may display the identifier as the scroll down when the display device 100 performs the scroll down operation as illustrated in FIG. 13.

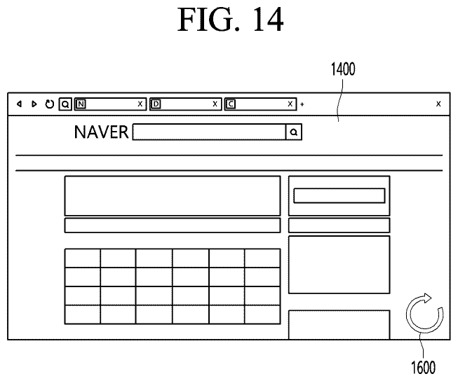

FIGS. 14 to 18 are views for explaining the scroll operation of the display device according to an embodiment of the present disclosure.

As illustrated in FIGS. 14 to 18, when the screen information control signal does not contain the button data and only contains the scroll data, the display device may scroll the screen information corresponding to the scroll data, and when the screen information control signal does not contain the scroll data and only contains the button data, the display device may process the screen information corresponding to the button data.

As illustrated in FIG. 14, when scrolling the screen information 1400 having one page, the display device may confirm whether a previous page exists in the current page of the screen information if the scroll data is command data instructing the scroll up operation, and may refresh the current page of the screen information 1600 if the previous page does not exist as a result of the confirmation.

In addition, when scrolling the screen information 1400 having one page, the display device may confirm whether a next page exists in the current page of the screen information if the scroll data is command data instructing the scroll down operation, and may refresh the current page of the screen information 1600 if the next page does not exist as a result of the confirmation.

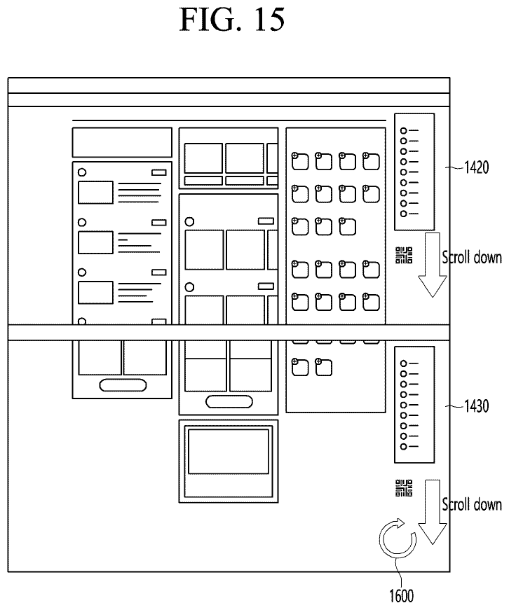

As another example, as illustrated in FIG. 15, when scrolling the screen information having a plurality of pages, the display device may move the current page 1420 of the screen information in the down direction when the scroll data is command data that instructs the scroll down operation, switch the current page 1420 into a next page 1430 of the screen information when the next page 1430 of the screen information exists, and refresh 1500 the current page of the screen information when the next page 1430 of the screen information does not exist.

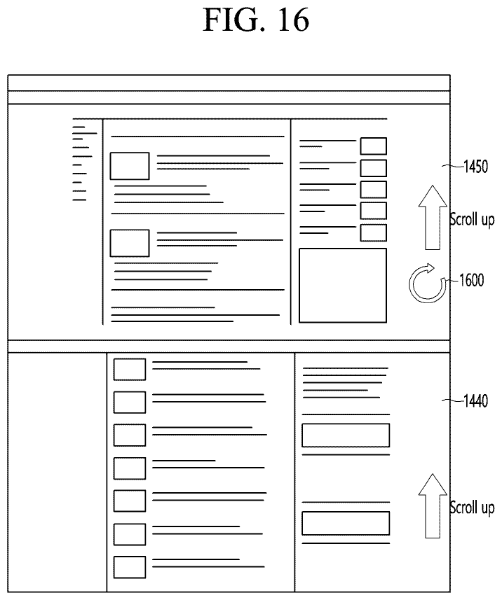

In addition, as illustrated in FIG. 16, when scrolling the screen information having a plurality of pages, the display device may move the current page 1440 of the screen information in the up direction when the scroll data is command data that instructs the scroll down/up operations, switch the current page 1420 into a previous page 1450 of the screen information when the previous page 1450 of the screen information exists, and refresh 1500 the current page of the screen information when the previous page 1450 of the screen information does not exist.

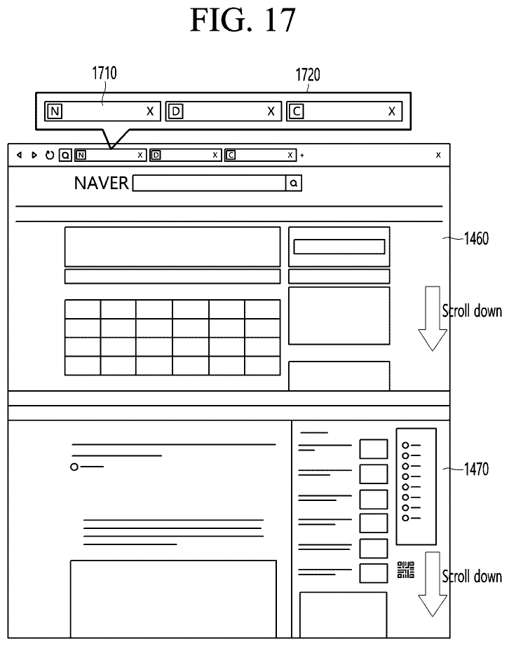

As another example, as illustrated in FIG. 17, when scrolling the screen information, in a state in which a cursor displayed on the display screen is disposed within an address window 1710 of the screen information, if a scroll function of the specific button is activated on the basis of the screen information control signal corresponding to the specific button of the remote control device, the display device 100 may display a user's access history 1720 around the address window and scroll the screen information to move to a corresponding access page according to the access history 1720.

Here, the display device may sequentially align the access pages corresponding to the user's access history 1720, move the current access page 1460 of the screen information in a down direction according to the sorting order of the plurality of access pages when the scroll data is command data instructing the scroll down operation, and switch the current access page to the next access page 1470 of the screen information when the next access page 1470 of the screen information exists.

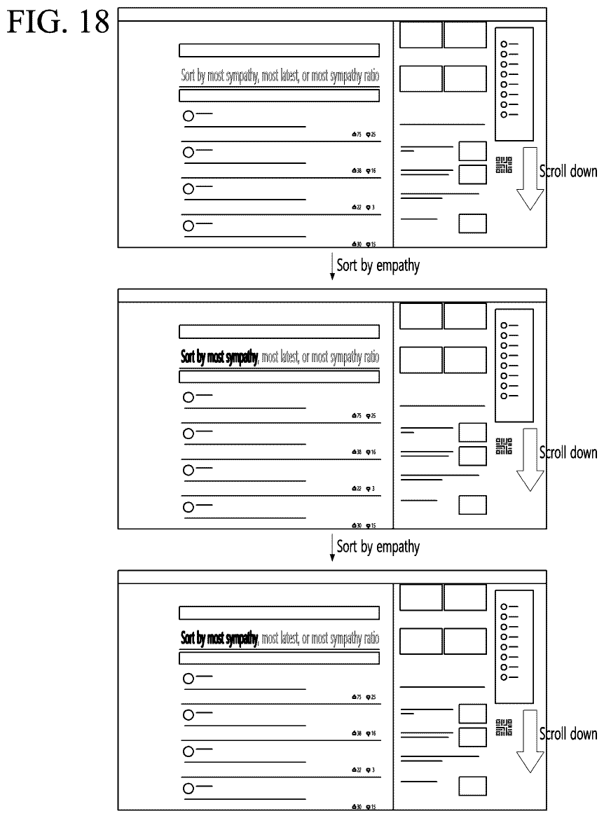

As further another example, as illustrated in FIG. 18, the display device may sort the corresponding access pages in any one of the following order: most sympathy, most latest, or most sympathy ratio when scrolling the screen information and then sequentially scroll the sorted access pages.

As described above, the remote control device may generate the screen information control signal containing the scroll data on the basis of the press time of the specific button to transmit the screen information control signal to the display device, thereby controlling the scroll operation of the screen information displayed on the display device while maintaining existing usability by using the replacement button instead of the wheel button, and thus, the defect rate due to the removal of the wheel button may be improved, user the convenience may be improved, and the slim design may be enabled.

The above-described present disclosure may be implemented as a computer-readable code on a computer-readable medium in which a program is stored. The computer readable recording medium includes all types of recording devices in which data readable by a computer system is stored. Examples of the computer-readable recording medium include hard disk drives (HDD), solid state disks (SSD), silicon disk drives (SDD), read only memories (ROMs), random access memories (RAMs), compact disc read only memories (CD-ROMs), magnetic tapes, floppy discs, and optical data storage devices. In addition, the computer may include a processor (180) of an artificial intelligence device.

### INDUSTRIAL APPLICABILITY

In the remote control device according to the present disclosure, the defect rate due to the removal of the wheel button may be improved, the user convenience may be improved, and the slim design may be realized, and thus, industrial applicability is remarkable.

What is claimed is:

1. A remote control device for controlling a display device, the remote control device comprising:
a communication unit;
a user input unit comprising a plurality of user buttons; and
a control unit configured to control the communication unit so as to transmit a screen information control signal corresponding to each of the user buttons,
wherein the control unit is configured to:
measure a press time of a specific button when the specific button of the plurality of user buttons is pressed;
transmit a screen information control signal containing button data to the display device when the press time of the specific button is less than or equal to a first set time; and
transmit a screen information control signal containing scroll data when the press time of the specific button exceeds the first set time.

2. The remote control device according to claim 1, wherein the screen information control signal is input as a data packet containing payload data having the a button data area and a scroll data area.

3. The remote control device according to claim 2, wherein the button data area comprises button data having a radio frequency (RF) key code, and
the scroll data area comprises scroll data having a scroll value.

4. The remote control device according to claim 2, wherein, when the press time of the specific button is less than or equal to the first set time, the control unit is configured to transmit a screen information control signal, in which the button data is contained in the button data area, and the scroll data is not contained in the scroll data area, to the display device so that a main function of the specific button is performed.

5. The remote control device according to claim 2, wherein, when the press time of the specific button exceeds the first set time, the control unit is configured to transmit a screen information control signal, in which the button data is not contained in the button data area, and the scroll data is contained in the scroll data area, to the display device so that a scroll function of the specific button is performed.

6. The remote control device according to claim 2, wherein the control unit is configured to:
confirm a pressed state of the specific button at a second set time interval after transmitting a screen information control signal, in which the scroll data is contained in the scroll data area, to the display device; and
repeatedly transmit a screen information control signal, in which the scroll data is contained in the scroll data area, to the display device so that a scroll function of the specific button is performed when the pressed state of the specific button continues.

7. The remote control device according to claim 6, wherein the control unit is configured to:
confirm the pressed state of the specific button at a second set time interval; and
transmit a screen information control signal, in which the button data is contained in the button data area, to the display device so that a main function of the specific button is performed when the pressed state of the specific button is ended.

8. The remote control device according to claim 1, wherein the control unit is configured to:
transmit a plurality of screen information control signals, which contain the same button data and do not contain the scroll data, to the display device at a first time interval when the press time of the specific button is less than or equal to a first set time; and
transmit a screen information control signal, which does not contain the button data and contains the scroll data, to the display device at a second time interval when the press time of the specific button exceeds the first set time.

9. The remote control device according to claim 8, wherein the first time interval is shorter than the second time interval.

10. The remote control device according to claim 1, wherein the control unit is configured to transmit the screen information control signal to the display device at the first set time so that the display device generates and display a guide message for activating a scroll function on the basis of the screen information control signal.

11. The remote control device according to claim 1, wherein the control unit is configured to transmit the screen information control signal, which contains the scroll data, to the display device so that the display device generates and displays a notification message for notifying start of activation of the scroll function of the specific button.

12. A method for controlling an operation of a display device using a remote control device, the method comprising:
receiving a user input for pressing a specific button among a plurality of user buttons;
measuring a press time of the specific button;
confirming whether the press time of the specific button exceeds a first set time;
transmitting a screen information control signal, which contains scroll data, to the display device when the press time of the specific button exceeds the first set time;
measuring a press time of the specific button;
confirming whether the press time of the specific button exceeds a second set time; and
transmitting the screen information control signal, which contains the scroll data, to the display device when the press time of the specific button exceeds the second set time.

13. The method according to claim 12, wherein the confirming of whether the press time of the specific button exceeds the first set time comprises transmitting a screen information control signal, which contains button data and does not contain the scroll data, to the display device so that a main function of the specific button is performed when the press time of the specific button is less than or equal to the first set time.

14. The method according to claim 12, wherein the measuring of the press time of the specific button comprises measuring the press time of the specific button from a time point at which the screen information control signal, which contains the scroll data, is transmitted to the display device.

15. The method according to claim 12, wherein the confirming of whether the press time of the specific button exceeds the second set time comprises transmitting a screen information control signal, which contains button data and does not contain the scroll data, to the display device so that a main function of the specific button is performed when the press time of the specific button is less than or equal to the second set time.
